(19) United States
(12) Patent Application Publication
(10) Pub. No.: US 2025/0326302 A1
(43) Pub. Date: Oct. 23, 2025

(54) Electric Work Vehicle

(71) Applicant: Kubota Corporation, Osaka-shi (JP)

(72) Inventor: Hiroki Bessho, Sakai-shi (JP)

(21) Appl. No.: 19/095,268

(22) Filed: Mar. 31, 2025

(30) Foreign Application Priority Data
Apr. 17, 2024 (JP) 2024-066981

(51) Int. Cl. B60L 50/61; B60P 1/28; B60P 1/43; H02K 7/18

(52) U.S. Cl. CPC B60L 50/61; B60P 1/28; B60P 1/435; H02K 7/1815; B60L 2200/36

(57) ABSTRACT

An electric work vehicle includes a body supported by a travel unit; an electric motor provided for the body and configured to drive the travel unit; and a battery provided for the body and configured to supply electric power to the electric motor. The vehicle further includes an engine power generator having: a casing; a power generation section in the casing; and an engine in the casing, configured to drive the power generation section.

### CROSS-REFERENCE TO RELATED APPLICATION

This application claims priority to Japanese Patent Application No. 2024-066981 filed Apr. 17, 2024, the disclosure of which is hereby incorporated by reference in its entirety.

### BACKGROUND OF THE INVENTION

### Field of the Invention

The present invention relates to an electric work vehicle having an electric motor for driving a travel unit.

### Description of Related Art

An electric work vehicle has been known which includes: a body (body frame) supported by travel units (front wheels and rear wheels); an electric motor in the body for driving the travel units; and a battery in the body for supplying electric power to the electric motor (see, for example, Japanese Patent Publication No. 6810810).

In the above electric work vehicle, it is necessary to charge the battery in order to perform work travel beyond a cruising distance (all-electric range). However, in general, there is no power source at a work site and the battery cannot be charged. In order to perform the work travel beyond the cruising distance, the vehicle or battery must be moved to a location where charging is possible.

### SUMMARY OF THE INVENTION

The present invention provides an electric work vehicle which facilitates work travel beyond the cruising distance.

An electric work vehicle of the present invention includes: a body supported by a travel unit; an electric motor provided for the body and configured to drive the travel unit; and a battery provided for the body and configured to supply electric power to the electric motor, the vehicle further including an engine power generator having: a casing; a power generation section in the casing; and an engine in the casing configured to drive the power generation section.

With the above configuration, electric power can be supplied from the engine power generator. Therefore, even in a work site where there is no power source, the battery can be charged without moving the vehicle or the battery to a place where the charging is possible, and the work is facilitated while performing work travel beyond the cruising distance.

With the above configuration, the engine power generator can be operated and the battery can be charged while the vehicle is traveling, and the battery can be charged without stopping the work. In addition, the engine power generator can supply electric power to other work devices, such as backhoe and mower, at the work site.

In the present invention, the engine power generator may be loadable on and unloadable from the body.

With the above configuration, the engine power generator can be unloaded from the body to a site where work can be easily performed, and thus inspection, repair and the like of the engine power generator is facilitated.

In the present invention, the body may include a cargo bed, and the engine power generator may be in the cargo bed.

With the above configuration, the cargo bed is used as a mount stage for the engine power generator. There is no need to provide a special mount stage and thus the cost can be saved.

In the present invention, the cargo bed may be switchable to a dumping orientation in which a front part of the cargo bed is swung and lifted about a cargo bed pivot axis extending in a width direction in a rear part of the cargo bed.

With the above configuration, the cargo bed can be placed in the dumping orientation, i.e., in a sloped orientation in which the cargo bed is sloped rearward. Therefore, loading and unloading of the engine power generator is facilitated.

In the present invention, the rear part of the cargo bed may include a rear gate, and a lower rear part of the cargo bed may include a gate pivot axis extending in the width direction, and the rear gate may be swingably openable and closable about the gate pivot axis.

With the above configuration, by placing the cargo bed in the dumping orientation and the rear gate in the open orientation, the cargo bed in a sloped orientation in which the cargo bed is sloped rearward can be extended toward the ground through the rear gate. Therefore, loading and unloading of the engine power generator on and from the cargo bed is facilitated.

In the present invention, the front part of the cargo bed may have a winch.

With the above configuration, the engine power generator can be loaded onto the cargo bed through pulling by the winch, and the engine power generator can be unloaded from the cargo bed while being held by the winch under tension. Therefore, loading and unloading of the engine power generator is facilitated.

### BRIEF DESCRIPTION OF THE DRAWINGS

FIG. 1 is a left side view of an electric utility vehicle with an engine power generator mounted thereon.

FIG. 2 is a side view showing loading and unloading of the engine power generator on and from a cargo bed.

FIG. 3 is a side view of the engine power generator.

FIG. 4 is a diagram of a power transmission system for driving front and rear wheels.

### DESCRIPTION OF THE INVENTION

An embodiment of the present invention will be described below with reference to the drawings.

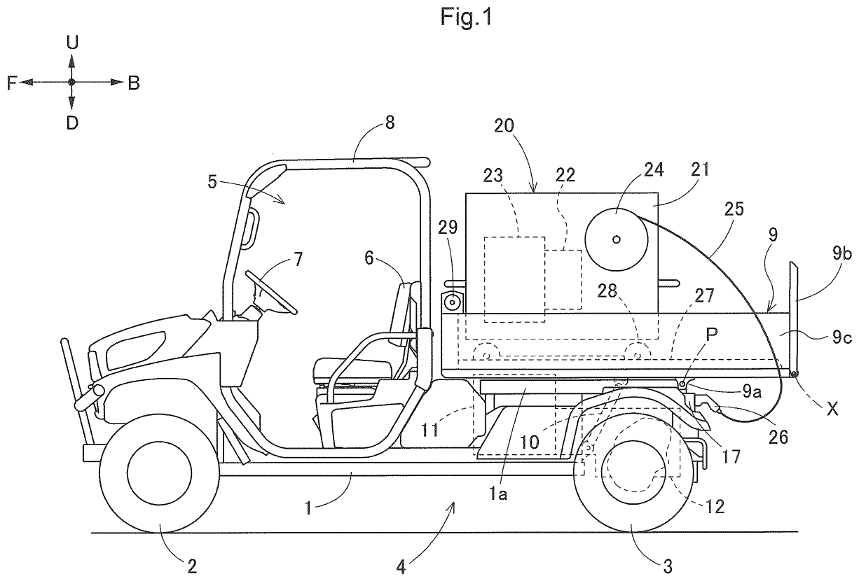

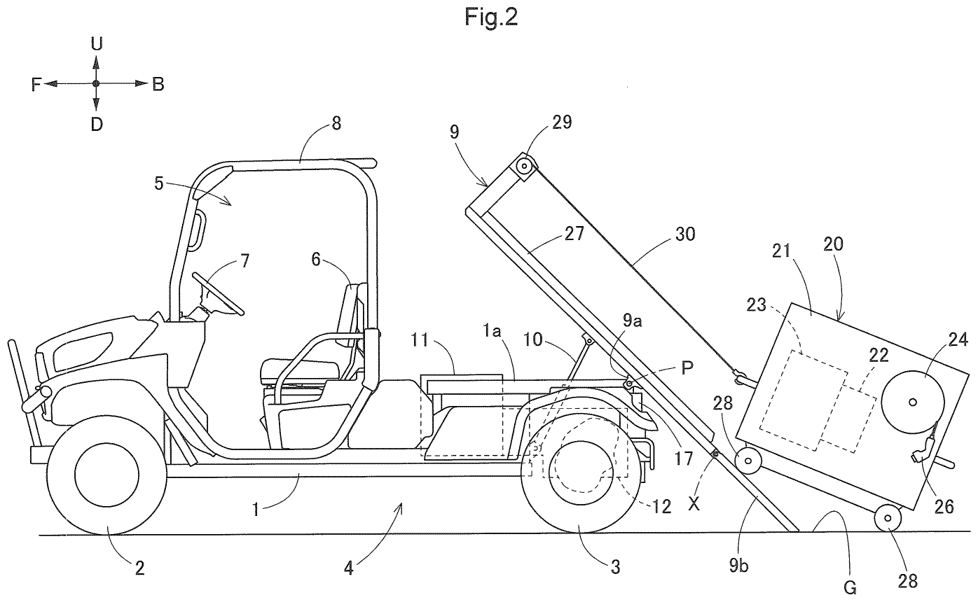

In the following description, with respect to the body of the electric utility vehicle (an example of “electric work vehicle”), a side indicated by an arrow F in FIGS. 1 and 2 is a “front” side of the body, a side indicated by an arrow B in FIGS. 1 and 2 is a “rear” side of the body, a side indicated by an arrow U in FIGS. 1 and 2 is an “upper” side of the body, a side indicated by an arrow D in FIGS. 1 and 2 is a “lower” side of the body, a side indicated by an arrow L in FIGS. 1 and 2 is a “left” side of the body, and a side indicated by an arrow R in FIGS. 1 and 2 is a “right” side of the body. A right-left direction of the body corresponds to a transversal direction of the body, and may also be referred to as a “width” direction or a “lateral” direction of the body. A front-rear direction of the body corresponds to a longitudinal direction of the body.

### Entire Structure of Electric Utility Vehicle

An electric utility vehicle shown in FIG. 1 is used for various purposes, such as load carriage and recreation. The electric utility vehicle includes a body 4 with a body frame 1. A pair of front travel units 2 (one right and one left), which are steerable and drivable, are forward of the body frame 1. A pair of rear travel units 3 (one right and one left), which are drivable, are rearward of the body frame 1. The body 4 is supported by the front travel units 2 and the rear travel units 3.

In the present embodiment, the front travel units 2 and the rear travel units 3 are tire wheels. A ride section 5 is in a front part of the body 4.

The ride section 5 includes a driver's seat 6, a steering wheel 7 for steering the front travel units 2, and a ROPS (roll-over protection system) 8 defining a ride space. A cargo bed 9 and an engine power generator 20 are in a rear part of the body 4. An electric motor 11 for traveling is below the cargo bed 9.

As shown in FIG. 1, in addition to the electric motor 11 for traveling, a gear transmission 12 and the like are below the cargo bed 9 and make the front travel units 2 and the rear travel units 3 drivable.

Specifically, as shown in FIG. 4, the electric motor 11 is connected to an inverter 14 which is connected to a battery 15. The inverter 14 and the battery 15 are mounted on the body 4 below the cargo bed 9 or below the driver's seat 6. The electric motor 11 is connected to the gear transmission 12.

Direct-current power stored in the battery 15 is converted into alternating-current power by the inverter 14, and the alternating-current power is supplied to the electric motor 11 and drives the electric motor 11 to generate a motive power. The motive power of the electric motor 11 is input to the gear transmission 12 to generate a rearward travel power and a forward travel power.

The rearward travel power is transmitted to the right and left rear travel units 3 through a rear differential mechanism (not shown) in the gear transmission 12. The forward travel power is transmitted to the right and left front travel units 2 through a front differential mechanism (not shown) in a support casing for the front travel units (not shown).

### Charging of Battery

As shown in FIG. 1, the engine power generator 20 is in the rear part of the body 4 and configured to generate electric power for charging the battery 15. In the present embodiment, the engine power generator 20 is mounted on the body 4 by placing the engine power generator 20 in the cargo bed 9.

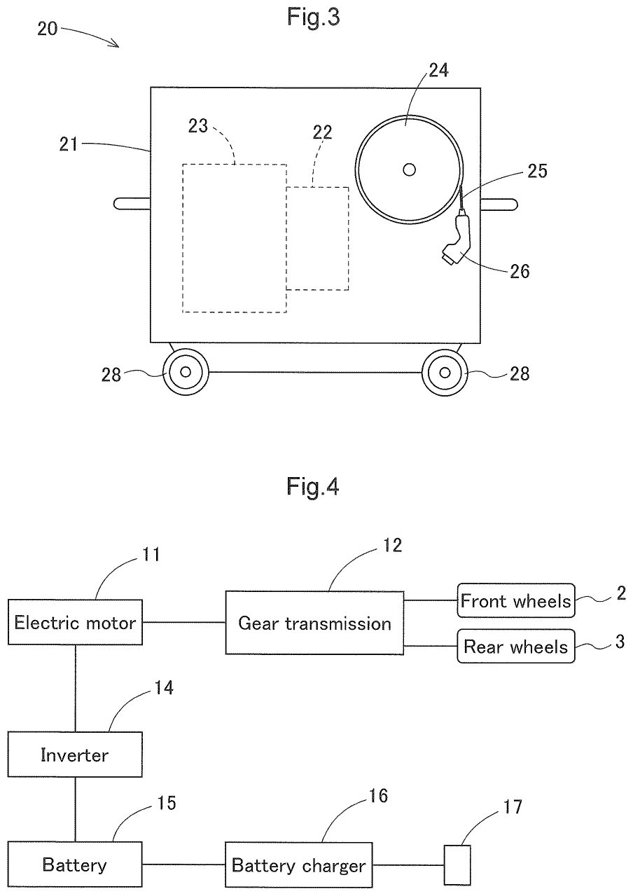

Specifically, as shown in FIG. 3, the engine power generator 20 has a casing 21.

The casing 21 is a component different from components of the body 4, such as the body frame 1. A power generation section 22 and an engine 23 are in the casing 21. In the present embodiment, the engine 23 is a diesel engine, but it may be a gasoline engine. The power generation section 22 is connected to the engine 23 which drives the power generation section 22. A side wall of the casing 21 has an output section 24 that includes a charging cable 25. The charging cable 25 is windable into and unwindable (drawable) from the output section 24. A distal end portion of the charging cable 25 has a feed connector 26.

In the engine power generator 20, the engine 23 drives the power generation section 22 to generate electric power, which is then taken out from the output section 24 and supplied to the charging cable 25.

As shown in FIG. 4, the battery 15 is connected to a battery charger 16 with a power receiving connector 17. In the present embodiment, the power receiving connector 17 is in the rear part of the body 4.

Referring to FIG. 1 in which the feed connector 26 of the engine power generator 20 is connected to the power receiving connector 17 of the battery charger 16, when the engine power generator 20 is activated, electric power is generated by the engine power generator 20 and sent from the charging cable 25 through the feed connector 26 and the power receiving connector 17 to the battery charger 16, and then received by the battery 15.

### Loading and Unloading of Engine Power Generator

As shown in FIG. 1, in a rear lower part of the cargo bed 9, right and left joints 9a are provided. The right and left joints 9a are swingably supported by right and left cargo bed-support frame sections la of the body frame 1, respectively. The right and left joints 9a have a cargo bed pivot axis P extending therebetween in a width direction of the body. The cargo bed 9 is vertically swingably supported by the body frame 1 about the cargo bed pivot axis P. A lower part of the cargo bed 9 and the body frame 1 are connected through a cylinder 10. Through expansion and contraction operations of the cylinder 10, the cargo bed 9 is switchable between a dumping orientation in which a front part of the cargo bed 9 is swung and lifted and the cargo bed 9 is sloped rearward (see FIG. 2) and a transport orientation in which the front part of the cargo bed 9 is swung and lowered and the cargo bed 9 is in a horizontal state (see FIG. 1).

As shown in FIG. 1, a rear part of the cargo bed 9 has a rear gate 9b and a lower rear part of the cargo bed 9 has a gate pivot axis X extending in the width direction. The rear gate 9b is supported by the cargo bed 9, and switchable between an open orientation in which the rear gate 9b is swung and lowered (see FIG. 2), and a close orientation in which the rear gate 9b is swung and lifted (see FIG. 1).

In each of left and right portions in the cargo bed 9, a guide rail 27 extends in a front-rear direction of the cargo bed 9. The left guide rail 27 is configured to engage with two rotatable left ring bodies 28 arranged in the front-rear direction in a lower left portion of the casing 21 and to guide the left ring bodies 28. The right guide rail 27 is configured to engage with two rotatable right ring bodies 28 arranged in the front-rear direction in a lower right portion of the casing 21 and to guide the right ring bodies 28. In the present embodiment, a winch 29 is provided in the front part of the cargo bed 9. In the present embodiment, the winch 29 is an electric winch.

Based on loading and unloading procedures as shown below, the engine power generator 20 can be loaded and unloaded on and from the cargo bed 9.

Specifically, as shown in FIG. 2, by placing the cargo bed 9 in the dumping orientation and the rear gate 9b in the open orientation, the cargo bed 9 in a rearward sloped state is extended to a ground G with use of the rear gate 9b. The winch 29 is driven so as to wind up a cable 30, which has been unwound (drawn) from the winch 29 and connected to the engine power generator 20. Then, the winch 29 pulls up the engine power generator 20 from the ground G to the rear gate 9b, and then from the rear gate 9b to the cargo bed 9. When the engine power generator 20 reaches the cargo bed 9, the ring bodies 28 are engaged with the guide rails 27 and guided by the guide rails 27 to move forward, and the engine power generator 20 moves forward in the cargo bed 9. Subsequently, when the engine power generator 20 reaches a predetermined position in the cargo bed 9, the ring bodies 28 are fitted into respective recesses (not shown) in the guide rails 27 and fixed, and the engine power generator 20 is installed at the predetermined position in the cargo bed 9. It is noted that in FIG. 2, a lateral side gate 9c of the cargo bed 9 (see FIG. 1) is omitted and not shown for explanation.

On the other hand, for unloading the engine power generator 20, the winch 29 is driven so as to unwind the cable 30 connected to the engine power generator 20. Because the cargo bed 9 and the rear gate 9b are placed in a sloped orientation in which they are sloped rearward, the engine power generator 20 is held by the cable 30 (under tension) from the winch 29, while the ring bodies 28 are guided along the guide rails 27 and move rearward, then the engine power generator 20 is moved off from the cargo bed 9 to the rear gate 9b, and then from the rear gate 9b to the ground G.

### Other Embodiments

(1) In the embodiment above, the engine power generator 20 is mounted on the body 4 by being placed in the cargo bed 9, but mounting of the engine power generator 20 is not limited to this embodiment. The engine power generator 20 may be, for example, mounted on the body 4 by being placed between the ride section 5 and the cargo bed 9, or being placed in a mount space for the power generator provided rearward of the cargo bed 9 and in the body frame 1.

(2) In the embodiment above, the engine power generator 20 can be loaded and unloaded. However, it may be fixed to the body 4.

(3) In the embodiment above, the rear gate 9b can be opened and closed. However, the rear gate 9b may be one which cannot be opened and closed.

(4) In the embodiment above, the orientation of the cargo bed 9 is changeable to the dumping orientation. However, the cargo bed 9 may be one which is not changeable to the dumping orientation.

(5) In the embodiment above, the vehicle is provided with the winch 29. However, the vehicle may not have the winch 29.

### INDUSTRIAL APPLICABILITY

The present invention is applicable to various electric work vehicles, such as an electric utility vehicle and an electric tractor.

### REFERENCE SIGNS LIST

2 travel unit (front travel unit)
3 travel unit (rear travel unit)
4 body
9 cargo bed
9b rear gate
11 electric motor
15 battery
21 casing
22 power generation section
23 engine
29 winch
P cargo bed pivot axis
X gate pivot axis

1. An electric work vehicle comprising:
a body supported by a travel unit;
an electric motor provided for the body and configured to drive the travel unit; and
a battery provided for the body and configured to supply electric power to the electric motor,
wherein the vehicle further comprises:
an engine power generator comprising:
a casing;
a power generation section in the casing; and
an engine in the casing, configured to drive the power generation section.

2. The electric work vehicle according to claim 1, wherein the engine power generator is loadable on and unloadable from the body.

3. The electric work vehicle according to claim 1,
wherein the body comprises a cargo bed, and
wherein the engine power generator is in the cargo bed.

4. The electric work vehicle according to claim 3, wherein the cargo bed is switchable to a dumping orientation in which a front part of the cargo bed is swung and lifted about a cargo bed pivot axis extending in a width direction in a rear part of the cargo bed.

5. The electric work vehicle according to claim 4,
wherein the rear part of the cargo bed comprises a rear gate, and
wherein a lower rear part of the cargo bed comprises a gate pivot axis extending in the width direction, and the rear gate is swingably openable and closable about the gate pivot axis.

6. The electric work vehicle according to claim 4, wherein the front part of the cargo bed has a winch.
